(19) United States
(12) Patent Application Publication
(10) Pub. No.: US 2016/0227783 A1
(43) Pub. Date: Aug. 11, 2016

(54) AGROCHEMICAL FORMULATION AID FOR MICRONUTRIENT UPTAKE IN PLANTS, PLANT HEALTH BENEFITS AND HERBICIDE PERFORMANCE

(71) Applicant: Adjuvants Plus USA, INC., Lansing, MI (US)

(72) Inventors: William Gordon Brown, Kingsville (CA); Allan S. Hamill, N. Kingsville (CA)

(73) Assignee: Adjuvants Plus USA, INC., Lansing, MI (US)

(21) Appl. No.: 15/041,596

(22) Filed: Feb. 11, 2016

Related U.S. Application Data
(60) Provisional application No. 62/115,026, filed on Feb. 11, 2015.

(51) Int. Cl. A01N 57/20; A01N 37/38; A01N 37/10

(52) U.S. Cl. CPC A01N 57/20; A01N 37/10; A01N 37/38

(57) ABSTRACT

Use of an agrochemical formulation aid composition with organic acid herbicides, pesticides and the like comprising monocarbamide dihydrogen sulfate and micronutrients is described.

### RELATED APPLICATIONS

This application claims the benefit of U.S. Provisional Application No. 62/115,026 filed Feb. 11, 2015, which is hereby incorporated by reference.

### BACKGROUND

### A. Technical Field

Need for Micronutrients

Plants need the essential nutrients nitrogen, phosphorus and potassium—the N—P—K on fertilizer labels—in large amounts, so these are referred to as macronutrients. Plants also need essential micronutrients (also known as trace minerals) such as calcium, zinc, magnesium, iron and manganese. The role and importance of such micronutrients in crop production, as well as maintenance of human health and animal husbandry health, is well documented. Manganese is a cofactor in photosynthesis and zinc is a cofactor in the shikimic acid pathway, and thus, are most important in plant growth, reproduction and disease resistance.

Limitations on Micronutrient Uptake

Many plants suffer micronutrient deficiency. For example, many soils are naturally limiting in providing micronutrients, either because the soil lacks micronutrients or because the soil is high in pH. Micronutrients generally bind to soils, become insoluble in water and will not be absorbed or used by the plant. Extensive areas of soil in the North Central United States and Canada are deficient in plant-available manganese, zinc and iron.

Genetically-Enhanced Herbicide Tolerant or Resistant Crops

In the commercial production of crops, it is desirable to easily and quickly eliminate weeds from a field of crop plants by a treatment that could be applied to an entire field but which would control only weeds while leaving the crop plants unharmed. One solution is the use of crop plants which are naturally tolerant to a herbicide or have been genetically enhanced to tolerate a herbicide, so that when the herbicide was sprayed on a field of herbicide-tolerant or resistant crop plants or an area of cultivation containing the crop, the crop plants would continue to thrive while non-herbicide-tolerant weeds were killed or severely damaged. Crop resistance to specific herbicides can be conferred by engineering genes into crops which encode appropriate herbicide metabolizing enzymes and/or insensitive herbicide targets.

Today, genetically enhanced crops are commonly planted throughout the major cropgrowing regions of the world. Many of these crops have already been engineered to be resistant to herbicides glyphosate, Glufosinate, 2,4-D and dicamba.

Glyphosate acid is relatively insoluble in water, and consequently is typically formulated as a water-soluble salt such as, for example, the sodium, potassium, ammonium, isopropylamine, or monoethanolamine salts of glyphosate. Glyphosate is typically applied to the foliage of the target plant. After application, glyphosate is absorbed by the foliar tissue of the plant and translocated throughout the plant. Glyphosate noncompetitively blocks an important biochemical pathway which is common to virtually all plants, but which is absent in animals. Although glyphosate is very effective in killing or controlling the growth of unwanted plants, the uptake (i.e., absorption) of glyphosate by plant foliar tissue and translocation of glyphosate throughout the plant is relatively slow. Visual symptoms that a plant has been treated with glyphosate may not appear until one week or more after treatment. Plants can be made resistant to the herbicide glyphosate by transforming the plant with a gene encoding a modified enzyme 5enolpyruvylshikimate-3-phosphate synthase (EPSPS). Examples of such EPSPS genes are the AroA gene (mutant CT7) of the bacterium Salmonella typhimurium and the CP4 gene. Glyphosate-resistant plants can also be obtained by expressing a gene that encodes a glyphosate oxido-reductase enzyme or expressing a gene that encodes a glyphosate acetyl transferase enzyme. Glyphosate resistance is found in the vast majority of genetically-modified crops world-wide.

Glufosinate herbicide collectively refers to 2-amino-4-(hydroxymethylphosphinyl)butanoic acid {also called (2RS)-2-amino-4(hydroxyl(methyl)phosphinoyl)butyric acid) (Glufosinate); (2S)-2-amino-4-(hydroxymethylphosphinyl)butanoic acid {also called (2S)-2-amino-4[hydroxy(methyl)phosphinoyl]butyric acid} (Glufosinate-p); and 2-amino-4-(hydroxymethylphosphinyl)butanoic acid monoammonium salt {also called ammonium (2RS)-2amino-4-(methylphosphinato)butyric acid} (Glufosinate-ammonium). Glufosinate is a water soluble, phosphinic acid based herbicide used for broad spectrum weed control, and has been formulated with adjuvants, such as an alcohol ether sulfate which is neutralized to form a sodium salt but the ammonium salt can also be used, at a ratio of pesticide to adjuvant ranging from about 1:1 to about 1:5. Plants can be made resistant to Glufosinate by transforming a plant to express the enzyme encoding a phosphinothricin acetyltransferase (such as the bar or pat protein from Streptomyces species).

2,4-D (2,4-Dichlorophenoxyacetic acid) is a common systemic herbicide used in the control of broadleaf weeds. It is a member of the phenoxy family of auxinic herbicides and is manufactured from chloroacetic acid and 2,4-dichlorophenol. It is the most widely used herbicide in the world, and the third most commonly used in North America. 2,4-D is a highly selective herbicide that is toxic to broad leafed plants (dicots), but generally benign to grasses (monocots). Plants have been developed which have enhanced tolerance to the herbicide 2,4-D. The U.S. Department of Agriculture (USDA) has fully deregulated the Dow Chemical Company's “Enlist” labeled corn and soybean seeds, which are genetically modified to enhance tolerance to 2,4-D, as well as be resistant to glyphosate. See Wright, Terry R. et al. “Robust Crop Resistance to Broadleaf and Grass Herbicides Provided by Aryloxyalkanoate Dioxygenase Transgenes,” Proceedings of the National Academy of Sciences of the United States of America 107.47 (2010): 20240-20245. PMC. Web. 25 Jan. 2015.

Dicamba (3,6-dichloro-2-methoxybenzoic acid, or also called 3,6-dichloro-o-anisic acid) is a benzoic acid synthetic auxin herbicide used to selectively control a wide spectrum of broadleaf weeds. Dicamba is typically formulated as a salt, such as the sodium, potassium, diethanolamine, isopropylamine, diglycolamine, or dimethylamine salt. Generally, auxin herbicides such as dicamba mimic or act like natural auxin plant growth regulators. Auxin herbicides appear to affect cell wall plasticity and nucleic acid metabolism, which can lead to uncontrolled cell division and growth. The injury symptoms caused by auxin herbicides include epinastic bending and twisting of stems and petioles, leaf cupping and curling, and abnormal leaf shape and venation. When applied on sensitive plants, synthetic auxins such as dicamba are quickly absorbed by the plant leaves, stems and roots. They attack the plant by mimicking naturally occurring growth hormones that regulate processes such as cell elongation, protein synthesis and cell growth in the class of benzoic acid herbicides. Dicamba degrading enzymes are disclosed. See e.g. U.S. Pat. No. 7,105,724 and U.S. Pat. No. 8,119,380 to Weeks disclosing methods and materials for making and using transgenic dicambadegrading organisms. Monsanto Company has developed the Roundup Ready Plus Xtend System that will provided dicamba and glyphosate resistance to selected crops.

The four herbicides, as well as potentially other herbicides, however, act as chelating agents. Glyphosate was originally identified as a chelating agent. (U.S. Pat. No. 3,160,632 to Toy of Stauffer Chemical Co., Dec. 8, 1964). Glufosinate is a known chelator. (Christa Ambrose and Patrick E. Hoggard, “Metal complexes of Glufosinate,” Journal of Agricultural and Food Chemistry 1989 37 (5), 1442-1444). The chemical structure of 2,4-D makes it seem possible that it may be a chelating agent for divalent cations. (Johnson, Emmett J., and Arthur R. Colmer. “Relationship between magnesium and the physiological effects of 2, 4dichlorophenoxyacetic acid on Azotobacter vinelandii and Rhizobium meliloti” Journal of bacteriology 73.1 (1957): 139). Dicamba is a chelator. (C H L Kennard, B Kerr, E J O'Reilly and G Smith, “Metal complexes of dicamba. II. The crystal structure of catena-m-[Diaquabis-(3,6dichloro-2-methoxybenzoato(O,O′)]-calcium(II),” Australian Journal of Chemistry 37(8) 1757-1761 Published: 1984). The result is that upon introduction of the herbicide into the crop plant, the pesticide molecule complex with metal ions inside the plant (chelation) with a double ionic bond. This includes forming complexes with metals that are useful as micronutrients for the plant, such as Magnesium and Zinc, and, thus, reducing the availability of the ions for the crop's benefit.

The literature reports that glyphosate application negatively impacts micronutrient availability at least in some environmental situations. See, for example, Zobiole et al, “Nutrient Accumulation And Photosynthesis In Glyphosate-Resistant Soybeans Is Reduced Under Glyphosate Use,” Publications from USDA-ARS/UNL Faculty, 2010 (http://digitalcommons.unl.edu/cgi/viewcontent.cgi?article=1556&context=usdaarsfac pub; last accessed Jan. 26, 2015). The authors concluded that “Photosynthesis, nutrient accumulation and biomass production in glyphosate resistant soybean were strongly affected by glyphosate.” (Id., 1871). See also Bott, Sebastian, et al. “Glyphosate-induced impairment of plant growth and micronutrient status in glyphosate-resistant soybean (Glycine max L).” Plant and Soil 312.1-2 (2008): 185-194; Huber D. M., “What about glyphosate-induced manganese deficiency?,” Fluid J. 2007, 15, 20-22; Dodds D. M.; Hickman M. V.; Huber D. M., “Comparison of micronutrient uptake by glyphosate resistant and non-glyphosate resistant soybeans,” Proc. North Central Weed Sci. Soc. 2001, 56, 96; Dodds D. M.; Huber D. M.; Hickman M. V., “Micronutrient levels in normal and glyphosate-resistant soybean,” Proc. North Central Weed Sci. Soc. 2002, 57, 107.

One review article has suggested that yield data on glyphosate-resistant soybeans do not support the hypotheses that there are substantive mineral nutrition or disease problems that are specific to glyphosate-resistant soybeans. Duke S O, Lydon J, Koskinen W C, Moorman T B, Chaney R L, Hammerschmidt R., “Glyphosate Effects on Plant Mineral Nutrition, Crop

Rhizosphere Microbiota, and Plant Disease in Glyphosate-Resistant Crops,” Journal of

Agricultural and Food Chemistry 2012; 60(42):10375-10397. doi:10.1021/jf302436u. This review, however, was largely limited to soybeans. Further, even as to soybeans, the article acknowledges that some glyphosate-resistant soybean cultivars are more susceptible to micronutrient issues than others, and that the various contradictory results can be explained by differences in the soils, climatic conditions, and/or glyphosate-tolerant cultivars used. Thus, the article seemingly recognizes that under certain circumstances, application of glyphosate can result in micronutrient deficiencies in specific soils and with specific cultivars.

Difficulty in Providing Micronutrients

Micronutrients cannot be provided by simply spraying fields with micronutrients. Micronutrients applied to the soil will generally and mostly bind to the soil, be insoluble and not available for plant uptake. Plant surfaces are negatively charged, and, thus, will bind any micronutrients which are cationic.

It has been known to supply micronutrients to plants via chelates, such chelates have a neutral charge which allows chelated minerals to more easily pass into the leaves. However, much of the applied chelated micronutrients remain on the surface of the leaves and are not absorbed.

Applying micronutrients in a tank mix with glyphosate or other chelating herbicides is problematic, because the micronutrients will bind with the herbicide and thus reduce the effectiveness of the herbicides against weeds.

Micronutrients can be applied in a separate operation, but this increases production cost and growers time.

### SUMMARY

The description below provides systems and methods for effecting biocontrol in crops, and particularly includes a description of synergistic combinations of formulations and methods to facilitate good health and increase yield in herbicide tolerant and resistant plants.

In one aspect, a completely chelated micronutrient product created with monocarbamide dihydrogen sulfate (MCDS) or combinations with MCDS and citric acid that is scalable in quantity is used. Thus a unique application of micronutrients with agrochemicals onto agrochemical tolerant and resistant crops in a single-pass is achievable.

The methods can be utilized as part of an integrated pesticidal management program.

In one aspect a plant supporting formulation is described which by itself has beneficial effects in terms of the growth, appearance, production and/or yield of plants to which it is applied in use. The formulation is also suitable for use as a delivery vehicle, or a component of a delivery vehicle, for the delivery of one or more phytologically beneficial substances to a plant. The formulation is also suitable for distributing or translocating phytologically beneficial substances in plants, to provide for formulations incorporating such vehicles with or without at least one phytologically beneficial substance whereby at least some of the disadvantages of existing formulations may at least be reduced. In still another aspect, the formulation provides a method for producing such vehicles and a method of preparing formulations incorporating such vehicles and at least one phytologically beneficial substance, and to provide a method of administering such phytologically beneficial substances to a plant involving the use of the delivery vehicles which then also serves to effect the translocation or distribution of the phytologically beneficial substances in or on the plant.

In another aspect of the disclosure, the formulations described in this paper, preclude harm to plants from application of phytotoxicants, even when the plant has been genetically enhanced to be resistant to the main mode of action of the phytotoxicant.

In another aspect, disclosed tank mixes of improved formulations enhance both phytotoxicant effectiveness and reduce harm to the genetically-enhanced phytotoxicant-resistant plants.

In another aspect a plant supporting formulation is disclosed which is suitable for use as a delivery vehicle, or a component of a delivery vehicle, for the delivery of one or more phytologically beneficial substances to a plant, and distributing or translocating phytologically beneficial substances in plants. The formulations incorporating such vehicles with or without at least one phytologically beneficial substance is provided whereby at least some of the disadvantages of existing formulations may at least be reduced. And a method for producing such vehicles and a method of preparing formulations incorporating such vehicles and at least one phytologically beneficial substance is also disclosed. A method of administering such phytologically beneficial substances to a plant involving the use of the delivery vehicles of the invention which then also serves to effect the translocation or distribution of the phytologically beneficial substances in or on the plant.

The disclosed systems, methods and substance herein also provide a formulation by which required micronutrients can be delivered to an herbicide tolerant and resistant plant to replace micronutrients that are scavenged by the herbicide, so as to provide the necessary nutrition to the plant to increase the health of the plant and its crop yield.

To the accomplishment of the foregoing and related ends, certain illustrative aspects are described herein in connection with the following description. These aspects are indicative, however, of but a few of the various ways in which the principles of the claimed subject matter may be employed and the claimed matter is intended to include all such aspects and their equivalents. Other advantages and novel features may become apparent from the following detailed description when considered in conjunction with the drawings.

### DETAILED DESCRIPTION

### Definitions

The below terms used in this disclosure are defined as follows:

“cereal” means a monocot crop, and includes maize (corn), rice, wheat, barley, sorghum, millet, oats and rye.

“composition” means a combination of one or more active agents and/or another compound, carrier or composition, inert (for example, a detectable agent or label or liquid carrier) or active, such as a pesticide.

“control” and its inflections mean harm or damage to an undesired plant, part of the plant or plant propagation material, to such a level that an agronomic improvement is demonstrated

“protecting” and its inflections mean reducing any undesired effect or damage to a desired plant, part of the plant or plant propagation material, to such a level that an agronomic improvement is demonstrated.

“effective amount” means an amount sufficient to affect beneficial or desired results. An effective amount can be administered in one or more administrations.

“cultivated plants” means any plants which are grown where desired or planted, and include both native plants and plants which have been modified by breeding, mutagenesis or genetic engineering.

“pesticide” or “phytotoxicant” means any insecticide, herbicide, bactericide, fungicide or other chemical or other substances that impart phytotoxic responses, i.e., subtle to distinct hindrances to the physiological functions, to plants.

“plant propagation material” means all the generative parts of the plant such as seeds and vegetative plant material such as cuttings and tubers, which can be used for the multiplication of the plant. This includes seeds, roots, fruits, tubers, bulbs, rhizomes, shoots, sprouts and other parts of plants, including seedlings and young plants, which are to be transplanted after germination or after emergence from soil.

“plant” is a term that includes both cultivated plants and plant propagation materials.

“weed” is a plant which is growing where it is not desired or wanted.

“plant” is a term that includes both cultivated plants and plant propagation materials.

### Brief Overview

Provided are methods of treating crop plants by spraying the plants with agrochemicals and micronutrients.

Herbicide

The formulation may include any herbicide not negatively altered by the formulation. The herbicides particularly include the active ingredients glyphosate, 2,4-D, Glufosinate and dicamba, and combinations of one of more of such herbicides. One such mixture of glyphosate and dicamba is disclosed in Publication number US20140249026 A1, “Glyphosate composition for dicamba tank mixtures with improved volatility,” to Monsanto Technology LLC.

Some examples of the commercial versions of these herbicides include:

from Monsanto Company: Roundup ProMax, Roundup PowerMax; Roundup WeatherMax® (Glyphosate potassium salt) Landmaster II (glyphosate isopropylamine salt plus 2-4-D isopropylamine salt); Roundup Xtend (glyphosate and dicamba {pending regulatory approvals}).

from Dow AgroSciences LLC: Accord XRT II (glyphosate dimethylammonium salt); ENLIST DUO; Accord XRT (Glyphosate isopropylamine salt); ENLIST DUO (glyphosate dimethylammonium salt plus 2-4-D choline salt); DMA 4 IVM (2,4-D dimethlamine salt); from Syngenta: Touchdown Total (Glyphosate potassium salt); Banvel (dicamba dimethylamine salt); and from Bayer: Liberty, Ignite 280 SL, Rely 280 (Glufosinate ammonium).

Adjuvants

An adjuvant is any substance in a concentrated herbicide formulation or which is added to the spray tank that modifies application characteristics or herbicidal activity.

The most established method of introducing material or substances into plant cells is by spraying of the substance in the presence of adjuvants, such as surfactants, wetting agents, spreaders or stickers. By this technique material is sprayed onto leaves of plants in the presence of adjuvants which would cause the material to penetrate the waxy outer layer of leaves, thereby increasing contact between the material to be absorbed by the plant and the surface membrane of the leaf itself.

Most agricultural formulations also are not generally suitable for the effective delivery of a number of macro- and micro-nutrients, as well as a large number of pesticides and growth regulators. Most adjuvants are also incompatible with some materials and conditions and may result in toxic effects in plants and animals, and some adjuvants have the potential to be mobile and pollute surface or groundwater sources. The use of adjuvants may be problematic near water, as adverse effects may occur in some aquatic species.

Suitable wetting agents that may be present in the formulations which can be used according to the present disclosure include all substances which promote wetting and are customary in the formulation of active agrochemical substances, provided that care is applied to either avoid any adjuvants that can adversely affect the agronomic benefit of the disclosed system.

Patent Publication 20140371069, Short-Chain Alkyl Sulfonates in Pesticide Formulations and Applications, published Dec. 18, 2014, discloses formulations useful with Glufosinate ammonium.

Patent Publication 20140315722, Cationic Polymers Comprising A Hydrophobic Group As Deposition Enhancers For Pesticides And Crop Production Chemicals, published Oct. 23, 2014, discloses formulations useful with phenoxy carboxylic acids (e.g. 2,4-D-acid, MCPA) and benzoic acids (e.g. Dicamba-acid).

The compositions provided herein comprise at least one agriculturally acceptable penetrating adjuvant, surface-active agent and/or carrier. Suitable adjuvants, surface-active agents or carriers should not be phytotoxic to valuable crops, particularly at the concentrations employed in applying the compositions for selective weed control in the presence of crops, and should not react chemically with herbicidal components or other composition ingredients. Such mixtures can be designed for application directly to weeds or their locus or can be concentrates or formulations that are normally diluted with additional carriers and adjuvants before application. In some embodiments, these materials can be used interchangeably as an agricultural adjuvant, as a liquid carrier or as a surface active agent. Other exemplary additives for use in the compositions provided herein include but are not limited to compatibility agents, antifoam agents, sequestering agents, neutralizing agents and buffers, corrosion inhibitors, dyes, odorants, spreading agents, penetration aids, sticking agents, dispersing agents, thickening agents, freezing point depressants, antimicrobial agents, and the like. The compositions may also contain other compatible components, for example, other herbicides, plant growth regulants, fungicides, insecticides, and the like and can be formulated with liquid fertilizers or solid, particulate fertilizer carriers such as ammonium nitrate, urea and the like. The formulations can be solids, such as, for example, dusts, granules, water-dispersible granules, or wettable powders, or liquids, such as, for example, emulsifiable concentrates, solutions, emulsions or suspensions.

They can also be provided as a pre-mix or tank mixed.

The formulations preferably contain monocarbamide dihydrogen sulfate (or sulphate, and also known as urea sulfate or as monourea sulfuric acid adduct). Adjuvant compositions containing monocarbamide dihydrogen sulfate are disclosed in U.S. Pat. Nos. 6,936,572 and 7,247,602 (Canadian Patent Nos. 2,426,875 and 2,534,020). The compositions more preferably include phosphate esters and tallow amine ethoxylates, as well as anti-foaming and other wetting agents. These formulations provide suitable compositions for use with both micronutrients (chelated by such compositions or unchelated) and the simultaneous use with glyphosate, Glufosinate, 2,4-D, dicamba and other small organic acid pesticides.

One benefit of the preferred compositions is that formulations utilizing monocarbamide dihydrogen sulfate provide the same benefit as does ammonium sulfate (AMS or AS), but without creating volatile ammonium salts of the herbicidal compounds that can cause vapor drift problems. The most preferred formulations will not include any intentionally added AMS or any ammonium compound.

Micronutrients and Chelating Agents

Micronutrients that may be added to plants include manganese, zinc, copper, iron, boron, molybdenum, calcium, magnesium and selenium. Micronutrients can be incorporated into the formulations as elemental or powdered metals, but preferably are provided as salts or oxides, or they may be complexed to chelating agents, such as for example aminocarboxylates, such as EDTA, DTPA, HEDTA, EDDHMA and EDDHA.

Chelates can be synthetic or natural. Micronutrients can be provided by complexing them with long chain polysaccharides which can complex with cationic nutrients in clusters (nanoclusters), thus rendering the nutrient-chelate complex neutral. The chelators (ligand) then envelop the enclustered nutrients and shuttle them to the cell wall where they deliver their nutrients. The company Nutrichem in South Africa has marketed a series of chelating compounds complexing amino acids with various micronutrients, and known as Fulviensuur Spoormix, Aminocalcium, Aminopotas, Aminocopper, Aminozinc and Aminomanganese, as well as Spoormix Nutriboost (EDTA chelated) (http://nutrichem.co.za/products.asp, last accessed Jan. 15, 2015).

Preferably, the micronutrient product is a clear liquid that disperses completely and rapidly in water with totally chelated metal ions. The micronutrients can be provided in the sulfate monohydrate form. One benefit of the sulfate monohydrate form is that the plants are provided sulfur, which is a plant nutrient. The sulfate monohydrates, however, tend to be acidic. An acid based solution, pH 2 to 6, facilitates the chelation. The protonation of calcium, magnesium, zinc and manganese for ions for example is pH dependent and related to the pKa of the plant cell medium which the micronutrient solution helps facilitate in terms of bioactivity. However, benefits are obtained also from a formulation that is more physiological. To increase the pH of the formulation, the micronutrients can be provided in the form of a hydroxide monohydrate, which would be a strong base, and would increase the pH of the formulation. The most preferred physiological pH formulations would be at around pH 6.

### Example Application

The components of the mixtures described herein can be applied either separately or as part of a multipart herbicidal system. Thus, the herbicides, adjuvants and micronutrients described herein can be applied sequentially, but are preferably tank mixed with the other ingredients, as well as any other ingredients. The simultaneous application of herbicide, monocarbamide dihydrogen sulfate, adjuvant and micronutrient provides combined benefits of weed control and crop plant safety for use on herbicide tolerant and resistant plants. In some embodiments, the compositions described herein are employed in combination with one or more herbicide safeners, and/or with one or more plant growth regulators.

Liquid or dry products are diluted and suspended or solubilized in spray water for application. A pre-mixed formulation can be provided either as a concentrate which is diluted prior to use or in a ready-to-use form suitable for application. The final dilution is usually made with water, but can be made instead of, or in addition to, water, with, for example, liquid fertilizers, micronutrients, biological organisms, oil or solvents.

The concentration of the herbicides is that specified in the product label. Concentration is dependent on weed kill while not injuring the crop. With respect to adjuvants and micronutrients, in some embodiments, the concentration of the ingredients in the compositions described herein is from about 0.0005 to 98 percent by weight. In some embodiments, the concentration is from about 0.0006 to 90 percent by weight. In compositions designed to be employed as concentrates, the active ingredients, in certain embodiments, are present in a concentration from about 0.1 to 98 weight percent, and in certain embodiment's about 0.5 to 90 weight percent. Such compositions are, in certain embodiments, diluted with an inert carrier, such as water, before application.

Most preferably, the concentrate is a clear liquid solution of chelated divalent and trivalent ions up to a precipitation point whereby the micronutrient components, water conditioner and water result in micronutrient values of 1 to 8% weight by weight alone or 0 to 8% by element in mixtures of manganese, zinc, iron, calcium, magnesium, boron, copper, molybdenum or selenium for example.

The diluted compositions usually applied to the locus of plants at a maximum physiologically beneficial application rate. The composition can be applied at an application rate of up to 4 liters per acre, where the applied solution contains about 0.1 to 4% weight percent monocarbamide dihydrogen sulfate; about 0.0 to 2% weight percent of Mn; about 0.0 to 2% weight percent of Zn; with or without other ions present. The formulation as applied to the plants can be made by diluting with water a concentrated formulation comprising:

A. Formulation A

| Ingredient | % by wt. |
|---|---|
| Monocarbamide dihydrogen sulfate | 17 |
| Manganese (in sulphate monohydrate form) | 2.6 |
| Zinc (in sulphate monohydrate form) | 2.9 |
| Compatibility agents and water | remainder |

B. Formulation B

| Ingredient | % by wt. |
|---|---|
| Monocarbamide dihydrogen sulfate | 17 |
| Manganese (in sulphate monohydrate form) | 3.9 |
| Zinc (in sulphate monohydrate form) | 1.5 |
| Compatibility agents and water | remainder |

C. Formulation C

| Ingredient | % by wt. |
|---|---|
| Monocarbamide dihydrogen sulfate | 17 |
| Manganese sulphate monohydrate | 2.4 |
| Zinc sulphate monohydrate | 2.6 |
| Copper sulphate pentahydrate | 0.3 |
| Boric Acid | 0.06 |
| Compatibility agents and water | remainder |

D. Formulation D

| Ingredient | % by wt. |
|---|---|
| Monocarbamide dihydrogen sulfate | 17 |
| Manganese sulphate monohydrate | 5 |
| Compatibility agents and water | remainder |

The present compositions can be applied to plants or their locus by the use of conventional ground or aerial sprayers, or by addition to irrigation or paddy water, and by other conventional means known to those skilled in the art.

The formulations may provide plant health benefits including shorter number of days to harvest, and an improvement in stress tolerance resulting in higher yields. In the case of the present disclosures, there appears to be enhanced uptake. The composition can be used for different crop applications, different stages of crop growth, different weather or climate conditions, and target species to ameliorate the crop set back related to ion scavenging and reduced metabolism where genetic resistance is related to both shikimic acid pathway alteration and to enhanced degradation genetics to crops resistant to herbicides like 2,4-D and dicamba.

Preferred formulations do not contain any ammonia salts or other ammonia compounds. Ammonia salts are very soluble, but may be more prone to herbicide drift than other salts. It is for this reason that glyphosate is now provided as a potassium salt, 2,4-D is formulated as a choline salt, and dicamba is dicamba sodium, potassium, DMA, DGA or BAPMA (N,N-Bis-(aminopropyl) methylamine) salt. The latter two are considered low volatile salts.

### EXAMPLES

The following are examples of the above-described general disclosure. Compositions 2 and 3 have the following meanings:

Composition 2: a 1:1 ratio

| Ingredient | CAS # | % by wt. |
|---|---|---|
| Monocarbamide dihydrogen sulfate | 21351-39-3 | 16.86 |
| Manganese (in sulphate monohydrate form) | 10034-96-5 | 2.62 |
| Zinc (in sulphate monohydrate form) | 7446-19-7 | 2.91 |
| Compatibility agent blend | proprietary | 1.95 |
| Water | | 75.66 |
| Total | | 100 |

Composition 3: a 3:1 ratio

| Ingredient | CAS # | % by wt. |
|---|---|---|
| Monocarbamide dihydrogen sulfate | 21351-39-3 | 16.86 |
| Manganese (in sulphate monohydrate form) | 10034-96-5 | 3.93 |
| Zinc (in sulphate monohydrate form) | 7446-19-7 | 1.45 |
| Compatibility agent blend | proprietary | 1.95 |
| Water | | 75.81 |
| Total | | 100 |

The other adjuvants and compatibility agents in the above compositions include one or more tallow amine ethoxylates and phosphate ester(s), and small amounts of one or more of antifoaming agents, thinners and other compatibility agents.

N Tank: a commercial formulation of Adjuvants Plus Inc., Kingsville, Ontario, comprising monocarbamide dihydrogen sulfate, branched alcohol ethoxylate, tallow amine, phosphate ester, and other water conditioner and pH adjuster ingredients utilized to enhance glyphosate absorption into plants.

In all tables, means followed by same letter do not significantly differ (P=0.05, LSD).

### Example 1

Research conducted at Michigan State University: Dr. Don Penner

Influence of Water Conditioners on the Control of Velvetleaf 21 DAT in the Greenhouse.

| | 2,4-D | 2,4-D | |
|---|---|---|---|
| | DMA | Acid | Dicamba |
| | (% | (% | DGA |
| Treatment | control) | control) | (% control) |
| Control | 0 | 0 | 0 |
| Herbicides | 29 g | 31 g | 36 g |
| Alone | | | |
| +2% AMS | 58 def | 73 ab | 57 def |
| +1.25% | 61 cdef | 62 cde | 54 f |
| CANG | | | |
| +2.5% | 60 def | 76 a | 55 ef |
| CANG | | | |
| +0.5% | 63 cd | 64 cd | 60 cdef |
| NTANK | | | |
| +1.0% | 64 cd | 67 bc | 59 def |
| NTANK | | | |
| LSD (0.05) | 0 | 8 | 0 |

AMS = Diammonium sulfate
CANG = Class Act Next Generation, Product of Winfield Solutions
NT = N TANK, Product of Adjuvants Plus Inc.
2,4-D DMA = 2,4-D Dimethylamine at 0.1 kg a.e./ha
2,4-D Acid = Rugged, 2,4-D at 0.1 kg a.e/ha, Product of Winfield Solutions
Dicamba DGA = Clarity, dicamba diglycolamine, at 0.034 kg a.e/ha

**Means with no common letters are significantly different at p=0.05

### Example 2

A trial was conducted to evaluate the effect of early and or late application of glyphosate with Composition 2 on yield of glyphosate resistant canola. The RR canola was Nexera 1012. The trial was conducted on a silt loam soil with 40-47% sand, 30-50% silt and 10-23% clay, 1.4-2.9% organic matter, and pH of 6.4-8.2. The plot was planted to field pea and then hard red spring wheat the previous two years. Treatments were arranged in a randomized complete block design with four (4) replications each while the control (no-Composition 2) was replicated only twice. Plots were seeded with Nexera 1012 at seeding depth of about 1.2 to 2.5 cm, 10° C. soil temperature and plant population of approximately 110-115 seeds m2. Plants were fertilized with 87-31-9-22 N—P—K—S pounds per acre via spreading urea and potash and putting phosphorus (Alpine and 11-52-0) and sulfur through the drill. In-crop application of glyphosate at a rate of 0.45 kg ha-1 (180 g/ac) with Composition 2 at 1 L/ac was applied at 3-4 leaf stage (Early application), 6 leaf stage (Normal application), after 10 leaf stage (late) and at both 3-4 leaf and after 10 leaf stages (Early/late application). The control treatments were sprayed with glyphosate alone. Each treatment was replicated four (4) times except the control treatment which had only two (2) replications.

Plant leaf tissues were collected at one and two weeks after spraying within each treatment to determine the mineral compositions. At physiological maturity with 70% of the seeds on the main raceme turned black, plants were swathed and allowed to cure for three weeks before being combined. Prior to swathing, fifty randomly selected plants were used for seed yield and yield components analysis. Data on number of fruits/plant, percent seed oil and seed protein were collected and analysed. An area of 1.1 ha of swath for each plot was combined and used for yield (bu/ac) determination. Seed yield (bu/ac) from combine was adjusted to 8% seed moisture content. Variables response to treatments were compared by analysis of variance (ANOVA) by using SPSS statistical software and mean values were subjected to ANOVA and significant means at F<0.05 were separated by the Duncan's multiple range test.

The results were that plant tissue samples one week after treatments showed varied concentration in manganese, zinc and nitrogen between the control (no-Composition 2 treatments) and the Early, Normal, Late and Early/Late Composition 2 applications. After one week of treatment application the Mn and Zn concentrations in the Early Composition 2 treatments recorded 19.4% and 36.7% increase respectively over the initial concentrations whereas the control had a significant drop of 13.4% and 14.5% respectively within the same period (Table 1). Similarly the Normal and Early/Late applications also recorded significant changes in Mn and Zn concentrations one week after Composition 2 application. There was 15.4% and 18.2% increase in Mn and Zn for the Normal and 27.7% and 12.8% for the Early/Late treatment respectively. The Late application only recorded slight increases in the concentration of Mn and Zn at one (1) week after Composition 2 application compared to either the Early or Normal treatments. The iron (Fe) concentrations were not significantly affected in the Early, Normal, Late and Early/Late treatments at one (1) week after Composition 2 application but the control (no-Composition 2) recorded a significant reduction (22.7%) in Fe (Table 2-1). The concentrations of phosphorus, potassium and sulphur were not affected at one or two weeks after treatments application (data not shown). Nitrogen concentration was similarly lower in the control and Late Composition 2 application treatments at both one and two weeks relative to the Early and Normal treatments. It is not known whether the lower Mn and Zn concentrations in the control or late treatments affected nitrogen metabolism. There were marked improvements in the concentrations of Fe, Mn and Zn for the control treatment at 2 weeks after application (Table 2-2) but were significantly lower compared to the other treatments.

In the Tables below, means in the same column followed by the same letter(s) are not significantly different according to LSD at p<0.05.

TABLE 2-1
Macro-nutrients, iron (Fe), manganese (Mn) and zinc (Zn) composition
in canola leaf tissues one week after glyphosate with or without
Composition 2 in spray volume.

| Treatments | % N | % P | % K | % S | Fe ppm | Mn ppm | Zn ppm |
|---|---|---|---|---|---|---|---|
| Initial | 4.0^{b} | 0.4^{a} | 4.2^{a} | 1.1 ^{a} | 110^{b} | 88.2^{b} | 24.2^{b} |
| Control | 3.7^{a} | 0.3^{a} | 4.1^{a} | 1.0^{a} | 85.1^{a} | 76.4^{a} | 20.7^{a} |
| Early | 5.2^{c} | 0.6^{a} | 4.6^{a} | 1.1^{a} | 109.4^{b} | 105.3^{c} | 33.1^{c} |
| Normal | 5.0^{c} | 0.5^{a} | 4.3^{a} | 1.1^{a} | 107.4^{b} | 101.8^{c} | 28.6^{b} |
| Late | 4.0^{b} | 0.3^{a} | 4.4^{a} | 1.1^{a} | 103.9^{b} | 91.4^{b} | 25.6^{b} |
| Early/Late | 5.1^{c} | 0.5^{a} | 3.8 ^{a} | 1.0^{a} | 112.7^{b} | 94.3^{b} | 27.3^{b} |

TABLE 2-2
Macro-nutrients, iron (Fe), manganese (Mn) and zinc (Zn) composition
in canola leaf tissues two weeks after glyphosate with or without
Composition 2 in spray volume.

| Treatments | % N | % P | % K | % S | Fe ppm | Mn ppm | Zn ppm |
|---|---|---|---|---|---|---|---|
| Initial | 4.0^{b} | 0.4 ^{a} | 4.2^{a} | 1.1 ^{a} | 110^{a} | 88.2^{a} | 28.0^{b} |
| Control | 4.6^{a} | 0.5^{a} | 4.3^{a} | 1.3^{a} | 105^{a} | 83.2^{a} | 22.6^{a} |
| Early | 6.3^{c} | 0.7^{b} | 4.7^{a} | 1.2^{a} | 166^{b} | 112.6^{c} | 35.3^{c} |
| Normal | 6.6^{c} | 0.7^{b} | 4.5^{a} | 1.2^{a} | 148^{b} | 108.2^{c} | 30.3^{b} |
| Late | 5.0^{b} | 0.5^{a} | 4.5^{a} | 1.1^{a} | 142^{b} | 94.3^{b} | 26.6^{b} |
| Early/Late | 6.6^{c} | 0.6^{ab} | 4.1 ^{a} | 1.1^{a} | 155^{b} | 96.2^{b} | 27.2^{b} |

Flowering in no-Composition 2 treated plots was delayed compared to Composition 2 treated plots. Staggered Composition 2 application resulted in differences from start to finish of flowering for the Control treatment compared to all other treatments. Plants in the Control (no Composition 2 treatment) were in the later stages of flowering whereas the other treatments especially the early stage (3-4 leaf stage) application were in the early or mid-pod filling stage.

Percent green counts were higher in the control treatments (no-Composition 2) compared to the Early, Normal and the Early/Late treatments. This was expected because the control treatments showed delayed flowering and swathing all treatments at the same time resulted in relatively higher immature seeds which were difficult to cure.

Number of fruits per plant was significantly lower in the control (78.5) and Late (81.4) applications compared to the Early (109.2), Normal (112.6) and Early/Late (115.5) treatments (Table 3). There were no significant differences among the mean number of fruits per plant from the Early, Normal and the Early/Late treatments however the Early/Late treatment recorded the highest number of fruits per plant (115.5).

Delay in flowering significantly affected the thousand seed weight for the Control and

Late treated plots. The thousand seed weight for the Control and late treatments were 3.1 g and 3.8 g respectively (Table 3). The Normal (6 leaf stage) treatments recorded the highest thousand seed weight of 4.8 g whereas the Early and the Early/Late treatments had 4.5 g and 4.6 g respectively.

Apart from the Control treatment which recorded significantly lower percent oil, the Early, Normal, Late and Early/Late treatments had comparable values. The oil content of canola from the Control plots was 37.7% while the Early, Normal, Late and Early/Late had 46.2%, 45.8%, 45.9% and 45.5% respectively. The percent protein followed a similar trend as the percent oil where the Control treatment recorded the lowest value (Table 3). Among the Composition 2 treated plots the early treatment had the lowest percent protein but a corresponding high percent oil. The trend in the percent protein concentration from the Normal, Late and Early/Late were fairly similar to that recorded for their percent oil. The protein concentration in the Normal and Late treatments was 19.5%, whereas the Early/Late had 19.6%.

The thousand seed weight (TSW) followed the order Normal>Early/Late>Early>Late>Control. TSW was lowest for the no-Composition 2 treatment (3.1 g) followed by the late treatment (3.8 g). The Early, Normal and the Early/Late treatment recorded 4.5 g, 4.8 g and 4.6 g TSW respectively. Differences in TSW values between the Normal, Early/Late and Early were not significant (Table 3).

Seed yield for the Control treatment was 40.9 bu/ac whereas the late treatment recorded 39.8 bu/ac (Table 2-3). The Late application recorded 1.1 bu/ac lower compared to the Control treatment. The Normal treatment yielded 43.9 bu/ac. whereas the highest seed weight (bu/ac) was recorded in the Early/Late treatment (45.0 bu/ac). The Early treatment also yielded 44.7 bu/ac but yield differences between Early, Normal and Early/Late were not significant. Since the Late treatments recorded the lowest seed yield it can therefore be deduced that the yield in the Early/Late treatments was only attributable to the Early Composition 2 application. Percent seed yield increase for the Early/Late, Early and the Normal compared to the Control were 10.0%, 9.3% and 7.3% respectively.

TABLE 2-3
Percent oil and protein concentration, fruits and seeds/plant, seed
yield (kg/ha) and percent yield increase over the control treatment.

| | No. of fruits | TSW | % | | Seed yield | % yield |
|---|---|---|---|---|---|---|
| Treatments | plant⁻¹ | (g) | Protein | % Oil | (bu/ac) | increase |
| Early | 109.2^{b} | 4.5_{b} | 18.6_{b} | 46.2_{b} | 44.7_{b} | 9.3* |
| (3-4 leaf) | | | | | | |
| Normal | 112.6^{b} | 4.8_{b} | 19.5_{b} | 45.8_{b} | 43.9_{b} | 7.3** |
| (6 leaf) | | | | | | |
| Late | 81.4ₐ | 3.8ₐ | 19.5_{b} | 45.9_{b} | 39.8ₐ | −2.7 |
| (8-10 leaf) | | | | | | |
| Early/Late | 115.5^{b} | 4.6^{b} | 19.6^{b} | 45.5^{b} | 45.0^{b} | 10.0** |

### Example 3

A trial was conducted to evaluate the effect of micronutrient addition to glyphosate treatment of RR soybeans (“GLXMA”). The RR soybeans were Asgrow 2433 RR.

The trial was conducted on loam soil with 3.2% organic material at 6.4 pH. Soil had following characteristics:

Lime index: 69.0

Phosphorus: 39 ppm

Potassium: 112 ppm

Magnesium: 230 ppm

Manganese: 20.4 ppm

Zinc: 3.1 ppm

Calcium: 1256 ppm

Treatments were arranged in a randomized complete block design and plot sizes were 10×35 feet. Two treatments were applied: Treatment 1 was at crop stage of 6″ height and V2 at 58° F.; Treatment 2 was at 16″ and V4 at 70° F.

The results are shown in the following Tables 2. In all tables, means followed by same letter do not significantly differ (P=0.05, LSD):

TABLE 3-1

| | | | | | | | | GLXMA | GLXMA |
|---|---|---|---|---|---|---|---|---|---|
| Trt | | Form | Form | | Rate | Grow | Appl | Injury % | greenness |
| No | Treatment Name | Conc | Type | Rate | Unit | Stg | Code | 13 DA-A | −10-+10 |
| 1 | Roundup PowerMax | 4.5 | SL | 32 | fl oz/a | V2 | A | 2 | −1 |
| 1 | N-Tank | | L | 0.5 | % v/v | V2 | A | | |
| 2 | Roundup PowerMax | 4.5 | SL | 32 | fl oz/a | V2 | A | 2 | −1 |
| 2 | COMPOSITION 2 | | L | 1 | qt/a | V2 | A | | |
| 2 | N-Tank | | L | 0.5 | % v/v | V2 | A | | |
| 3 | Roundup PowerMax | 4.5 | SL | 32 | fl oz/a | V2 | A | 2 | −1 |
| 3 | COMPOSITION 3 | | L | 1 | qt/a | V2 | A | | |
| 3 | N-Tank | | L | 0.5 | % v/v | V2 | A | | |
| 4 | Roundup PowerMax | 4.5 | SL | 32 | fl oz/a | V4 | B | 0 | 0 |
| 4 | N-Tank | | L | 0.5 | % v/v | V4 | B | | |
| 5 | Roundup PowerMax | 4.5 | SL | 32 | fl oz/a | V4 | B | 0 | 0 |
| 5 | COMPOSITION 2 | | L | 1 | qt/a | V4 | B | | |
| 5 | N-Tank | | L | 0.5 | % v/v | V4 | B | | |
| 6 | Roundup PowerMax | 4.5 | SL | 32 | fl oz/a | V4 | B | 0 | 0 |
| 6 | COMPOSITION 3 | | L | 1 | qt/a | V4 | B | | |
| 6 | N-Tank | | L | 0.5 | % v/v | V4 | B | | |

| | | |
|---|---|---|
| LSD (P = .05) | 2.3 | 1.2 |
| CV | 154.92 | 0.0 |

TABLE 3-2

| | | | | | | | | GLXMA | GLXMA |
|---|---|---|---|---|---|---|---|---|---|
| Trt | | Form | Form | | Rate | Grow | Appl | Injury % | greenness |
| No | Treatment Name | Conc | Type | Rate | Unit | Stg | Code | 14 DA-B | −10-+10 |
| 1 | Roundup PowerMax | 4.5 | SL | 32 | fl oz/a | V2 | A | 1 | −1 |
| 1 | N-Tank | | L | 0.5 | % v/v | V2 | A | | |
| 2 | Roundup PowerMax | 4.5 | SL | 32 | fl oz/a | V2 | A | 1 | −1 |
| 2 | COMPOSITION 2 | | L | 1 | qt/a | V2 | A | | |
| 2 | N-Tank | | L | 0.5 | % v/v | V2 | A | | |
| 3 | Roundup PowerMax | 4.5 | SL | 32 | fl oz/a | V2 | A | 0 | 0 |
| 3 | COMPOSITION 3 | | L | 1 | qt/a | V2 | A | | |
| 3 | N-Tank | | L | 0.5 | % v/v | V2 | A | | |
| 4 | Roundup PowerMax | 4.5 | SL | 32 | fl oz/a | V4 | B | 0 | 0 |
| 4 | N-Tank | | L | 0.5 | % v/v | V4 | B | | |
| 5 | Roundup PowerMax | 4.5 | SL | 32 | fl oz/a | V4 | B | 0 | 0 |
| 5 | COMPOSITION 2 | | L | 1 | qt/a | V4 | B | | |
| 5 | N-Tank | | L | 0.5 | % v/v | V4 | B | | |
| 6 | Roundup PowerMax | 4.5 | SL | 32 | fl oz/a | V4 | B | 0 | 0 |
| 6 | COMPOSITION 3 | | L | 1 | qt/a | V4 | B | | |
| 6 | N-Tank | | L | 0.5 | % v/v | V4 | B | | |

| | | |
|---|---|---|
| LSD (P = .05) | 2.3 | 1.2 |
| CV | 154.92 | 309.84 |

TABLE 3-3

| | | | | | | | | GLXMA | GLXMA |
|---|---|---|---|---|---|---|---|---|---|
| Trt | | Form | Form | | Rate | Grow | Appl | Injury % | greenness |
| No | Treatment Name | Conc | Type | Rate | Unit | Stg | Code | 28 DA-B | −10-+10 |
| 1 | Roundup PowerMax | 4.5 | SL | 32 | fl oz/a | V2 | A | 0 | 0 |
| 1 | N-Tank | | L | 0.5 | % v/v | V2 | A | | |
| 2 | Roundup PowerMax | 4.5 | SL | 32 | fl oz/a | V2 | A | 0 | 0 |
| 2 | COMPOSITION 2 | | L | 1 | qt/a | V2 | A | | |
| 2 | N-Tank | | L | 0.5 | % v/v | V2 | A | | |
| 3 | Roundup PowerMax | 4.5 | SL | 32 | fl oz/a | V2 | A | 0 | 0 |
| 3 | COMPOSITION 3 | | L | 1 | qt/a | V2 | A | | |
| | N-Tank | | L | 0.5 | % v/v | V2 | A | | |
| | Roundup PowerMax | 4.5 | SL | 32 | fl oz/a | V4 | B | 0 | 0 |
| 4 | N-Tank | | L | 0.5 | % v/v | V4 | B | | |
| 5 | Roundup PowerMax | 4.5 | SL | 32 | fl oz/a | V4 | B | 0 | 0 |
| 5 | COMPOSITION 2 | | L | 1 | qt/a | V4 | B | | |
| 5 | N-Tank | | L | 0.5 | % v/v | V4 | B | | |
| 6 | Roundup PowerMax | 4.5 | SL | 32 | fl oz/a | V4 | B | 0 | 0 |
| 6 | COMPOSITION 3 | | L | 1 | qt/a | V4 | B | | |
| 6 | N-Tank | | L | 0.5 | % v/v | V4 | B | | |

| | | |
|---|---|---|
| LSD (P = .05) | 0.0 | 0.0 |
| CV | 0.0 | 0.0 |

### Example 4

TABLE 3-4

| Trt | | Form | Form | | Rate | Grow | Appl | GLXMA yield |
|---|---|---|---|---|---|---|---|---|
| No | Treatment Name | Conc | Type | Rate | Unit | Stg | Code | bu/acre at 13% M |
| 1 | Roundup PowerMax | 4.5 | SL | 32 | fl oz/a | V2 | A | 73.4 |
| 1 | N-Tank | | L | 0.5 | % v/v | V2 | A | |
| 2 | Roundup PowerMax | 4.5 | SL | 32 | fl oz/a | V2 | A | 72.2 |
| 2 | COMPOSITION 2 | | L | 1 | qt/a | V2 | A | |
| 2 | N-Tank | | L | 0.5 | % v/v | V2 | A | |
| 3 | Roundup PowerMax | 4.5 | SL | 32 | fl oz/a | V2 | A | 73.9 |
| 3 | COMPOSITION 3 | | L | 1 | qt/a | V2 | A | |
| 3 | N-Tank | | L | 0.5 | % v/v | V2 | A | |
| 4 | Roundup PowerMax | 4.5 | SL | 32 | fl oz/a | V4 | B | 71.2 |
| 4 | N-Tank | | L | 0.5 | % v/v | V4 | B | |
| 5 | Roundup PowerMax | 4.5 | SL | 32 | fl oz/a | V4 | B | 76.3 |
| 5 | COMPOSITION 2 | | L | 1 | qt/a | V4 | B | |
| 5 | N-Tank | | L | 0.5 | % v/v | V4 | B | |
| 6 | Roundup PowerMax | 4.5 | SL | 32 | fl oz/a | V4 | B | 76.5 |
| 6 | COMPOSITION 3 | | L | 1 | qt/a | V4 | B | |
| 6 | N-Tank | | L | 0.5 | % v/v | V4 | B | |

| | |
|---|---|
| LSD (P = .05) | 8.01 |
| CV | 7.19 |

A trial was conducted to evaluate the effect of micronutrient addition to glyphosate treatment of RR corn (“ZEAMX”). The RR corn was DKC 48-12. The trial was conducted on loam soil with 3.1% organic material at 6.9 pH.

Treatments were arranged in a randomized complete block design and plot sizes were 10×35 feet. Treatments were applied at two different timings: Treatment 1 was at crop stage of 5″ height and V2 at air temperature 77° F.; Treatment 2 was at 8″ and V4 at 73° F.

TABLE 4-1

| | | | | | | | | ZEAMX | |
|---|---|---|---|---|---|---|---|---|---|
| Trt | | | | | | | | Injury % | ZEAMX |
| No | Treatment Name | Form | Form | Rate | Rate | Grow | Appl | 7/14/28 | DA-A/B |
| 1 | Roundup PowerMax | 4.5 | SL | 32 | fl oz/a | V2 | A | | 0 |
| 1 | N-Tank | | L | 0.5 | % v/v | V2 | A | | |
| 2 | Roundup PowerMax | 4.5 | SL | 32 | fl oz/a | V2 | A | 0 | −1 |
| 2 | COMPOSITION 2 | | L | 1 | qt/a | V2 | A | | |
| 2 | N-Tank | | L | 0.5 | % v/v | V2 | A | | |
| 3 | Roundup PowerMax | 4.5 | SL | 32 | fl oz/a | V2 | A | 0 | 0 |
| 3 | COMPOSITION 3 | | L | 1 | qt/a | V2 | A | | |
| 3 | N-Tank | | L | 0.5 | % v/v | V2 | A | | |
| 4 | Roundup PowerMax | 4.5 | SL | 32 | fl oz/a | V4 | B | 0 | 0 |
| 4 | N-Tank | | L | 0.5 | % v/v | V4 | B | | |
| 5 | Roundup PowerMax | 4.5 | SL | 32 | fl oz/a | V4 | B | 0 | 0 |
| 5 | COMPOSITION 2 | | L | 1 | qt/a | V4 | B | | |
| 5 | N-Tank | | L | 0.5 | % v/v | V4 | B | | |
| 6 | Roundup PowerMax | 4.5 | SL | 32 | fl oz/a | V4 | B | 0 | 0 |
| 6 | COMPOSITION 3 | | L | 1 | qt/a | V4 | B | | |
| 6 | N-Tank | | L | 0.5 | % v/v | V4 | B | | |

| | | |
|---|---|---|
| LSD (P = .05) | 0 | 0 |
| CV | 0 | 0 |

TABLE 4-2

| | | | | | | | | ZEAMX | ZEAMX |
|---|---|---|---|---|---|---|---|---|---|
| Trt | | Form | Form | | Rate | Grow | Appl | Moisture % | yield bu/acre |
| No | Treatment Name | Conc | Type | Rate | Unit | Stg | Code | 157 DA-B | at 15% M |
| 1 | Roundup PowerMax | 4.5 | SL | 32 | fl oz/a | V2 | A | 16.6 | 238 |
| 1 | N-Tank | | L | 0.5 | % v/v | V2 | A | | |
| 2 | Roundup PowerMax | 4.5 | SL | 32 | fl oz/a | V2 | A | 15.7 | 236 |
| 2 | COMPOSITION 2 | | L | 1 | qt/a | V2 | A | | |
| 2 | N-Tank | | L | 0.5 | % v/v | V2 | A | | |
| 3 | Roundup PowerMax | 4.5 | SL | 32 | fl oz/a | V2 | A | 17.4 | 220 |
| 3 | COMPOSITION 3 | | L | 1 | qt/a | V2 | A | | |
| 3 | N-Tank | | L | 0.5 | % v/v | V2 | A | | |
| 4 | Roundup PowerMax | 4.5 | SL | 32 | fl oz/a | V4 | B | 18.1 | 237 |
| 4 | N-Tank | | L | 0.5 | % v/v | V4 | B | | |
| 5 | Roundup PowerMax | 4.5 | SL | 32 | fl oz/a | V4 | B | 17.6 | 241 |
| 5 | COMPOSITION 2 | | L | 1 | qt/a | V4 | B | | |
| 5 | N-Tank | | L | 0.5 | % v/v | V4 | B | | |
| 6 | Roundup PowerMax | 4.5 | SL | 32 | fl oz/a | V4 | B | 16.7 | 244 |
| 6 | COMPOSITION 3 | | L | 1 | qt/a | V4 | B | | |
| 6 | N-Tank | | L | 0.5 | % v/v | V4 | B | | |

| | | |
|---|---|---|
| LSD (P = .05) | 1.92 | 26.5 |
| CV | 7.51 | 7.46 |

### Example 5

A trial was conducted to evaluate the effect of micronutrient addition to glyphosate treatment of RR soybeans (“GLXMA”). The RR soybeans were PRO 2625R2. The trial was conducted on North Gower Clay (heavy phase) soil with 4.0% organic material at 7.2 pH.

Treatments were arranged in a randomized complete block design and plot sizes were 16.3 m×1.5 m. There were six replicates. Two treatments timings were applied: Treatment 1 was at V2 2d trifoliate stage; Treatment 2 was at V4 4th trifoliate stage.

The results are shown in the following Tables 5-1 through 5-3.

TABLE 5-1

| | | | Health | |
|---|---|---|---|---|
| | | | Ratings 1- | |
| | | Growth | Poor, | |
| Treatment | Rep | Stage | 10Excellent) | Notes |
| 1 | 1 | 65% LD | 7 | Moderately |
| Foliar application | | | | uneven* |
| of Roundup | 2 | 65% LD | 8.5 | Moderately |
| WeatherMax at | | | | uneven |
| 1.0 L/acre, | 3 | 65% LD | 7.5 | Slightly |
| applied at 2nd | | | | uneven |
| trifoliate stage | 4 | 70% LD | 7.5 | Slightly |
| | | | | uneven |
| | 5 | 65% LD | 7 | Moderately |
| | | | | uneven |
| | 6 | 65% LD | 6.5 | Moderately |
| | | | | uneven |
| 2 | 1 | 80% LD | 8 | Very well |
| Foliar application | | | | podded, |
| of Roundup | | | | good |
| WeatherMax at | | | | health |
| 1.0 L/acre + | 2 | 85% LD | 8 | Well |
| COMPOSITION 2 | | | | podded |
| at 1.0 L/acre, | 3 | 80% LD | 8.5 | Very well |
| applied at 2nd | | | | podded, |
| trifoliate stage | | | | good |
| | | | | health |
| | 4 | 80% LD | 8.5 | Very well |
| | | | | podded, |
| | | | | good |
| | | | | health |
| | 5 | 85% LD | 8.5 | Very well |
| | | | | podded, |
| | | | | very good |
| | | | | health |
| | 6 | 80% LD | 8.5 | Very well |
| | | | | podded, |
| | | | | good |
| | | | | health |
| 3 | 1 | 80% LD | 8 | Very well |
| Foliar application | | | | podded |
| of Roundup | 2 | 80% LD | 8 | Well |
| WeatherMax at | | | | podded, |
| 1.0 L/acre + | | | | slightly |
| COMPOSITION 3 | | | | uneven |
| at 1.0 L/acre, | 3 | 80% LD | 8 | Well |
| applied at 2nd | | | | podded, |
| trifoliate stage | | | | slightly |
| | | | | uneven |
| | 4 | 80% LD | 8.5 | Well |
| | | | | podded |
| | 5 | 80% LD | 8 | Very well |
| | | | | podded |
| | 6 | 80% LD | 8.5 | Very well |
| | | | | podded |

*“uneven” means variation or lack of uniformity in plant height

TABLE 5-2

| | | | Health Ratings | |
|---|---|---|---|---|
| | | Growth | (1-Poor, | |
| Treatment | R | Stage | 10Excellent) | Notes |
| 1 | 1 | 80% LD | 8 | Slightly |
| Foliar application | | | | uneven |
| of Roundup | 2 | 76% LD | 7.5 | Moderately |
| WeatherMax at | | | | uneven |
| 1.0 L/acre, | 3 | 75% LD | 7.5 | Moderately |
| applied at 4th | | | | uneven |
| trifoliate stage | 4 | 70% LD | 7.5 | Moderately |
| | | | | uneven |
| | 5 | 72% LD | 7 | Moderately |
| | | | | uneven |
| | 6 | 70% LD | 7 | Moderately |
| | | | | uneven |
| 2 | 1 | 90% LD | 9.5 | Well |
| Foliar application | | | | podded, |
| of Roundup | | | | good |
| WeatherMax at | | | | health |
| 1.0 L/acre + | 2 | 92% LD | 9 | Very well |
| COMPOSITION 2 | | | | podded, |
| at 1.0 L/acre, | | | | good |
| applied at 4th | | | | health |
| trifoliate stage | 3 | 87% LD | 9 | Well |
| | | | | podded, |
| | | | | good |
| | | | | health |
| | 4 | 85% LD | 9 | Very good |
| | | | | health, |
| | | | | very well |
| | | | | podded |
| | 5 | 82% LD | 9.5 | Very well |
| | | | | podded, good |
| | | | | health |
| | 6 | 87% LD | 8.5 | Very well |
| | | | | podded, good |
| | | | | health |
| 3 | 1 | 88% LD | 9 | Good |
| Foliar application | | | | health, well |
| of Roundup | | | | podded |
| WeatherMax at | 2 | 86% LD | 8.5 | Very good |
| 1.0 L/acre + | | | | health, |
| | | | | very well |
| | | | | podded |
| COMPOSITION 3 | 3 | 86% LD | 8.5 | Very good |
| at 1.0 L/acre, | | | | health, |
| applied at 4th | | | | very well |
| trifoliate stage | | | | podded |
| | 4 | 83% LD | 8.5 | Well |
| | | | | podded, |
| | | | | good |
| | | | | health |
| | 5 | 82% LD | 8.5 | Well |
| | | | | podded, |
| | | | | good |
| | | | | health |
| | 6 | 87% LD | 8.5 | Well |
| | | | | podded, |
| | | | | good |
| | | | | health |

TABLE 5-3

| | | | | Yield |
|---|---|---|---|---|
| | | Bushel | | (bu/acre |
| | | Weight | | at 15% |
| Treatment | Leaf Stage | (lb/bu) | Moisture (%) | moisture) |
| 1 | 2nd | 56.2 | 14.7 | 54.9 |
| Foliar application of Roundup | trifoliate | | | |
| WeatherMax at 1.0 L/acre, applied at 4th | 4th trifoliate | 56.4 | 14.5 | 56.2 |
| trifoliate stage | | | | |
| Average | | 56.3 | 14.6 | 55.6 |
| 2 | 2nd | 56.4 | 14.7 | 61.9 |
| Foliar application of Roundup | trifoliate | | | |
| WeatherMax at 1.0 L/acre + | 4th trifoliate | 56.4 | 14.5 | 58.3 |
| COMPOSITION 2 at 1.0 L/acre, applied at 4th | | | | |
| trifoliate stage | | | | |
| Average | | 56.4 | 14.6 | 60.1 |
| 3 | 2nd | 56.2 | 14.6 | 58.0 |
| Foliar application of Roundup | trifoliate | | | |
| WeatherMax at 1.0 L/acre + | 4th trifoliate | 56.2 | 14.6 | 58.0 |
| COMPOSITION 3 at 1.0 L/acre, applied at 4th | | | | |
| trifoliate stage | | | | |
| Average | | 56.2 | 14.6 | 58.0 |

### Example 6

A trial was conducted to evaluate the effect of micronutrient addition to glyphosate treatment of RR corn (“ZEAMX”). The RR corn DeKalb DKC 39-97 R.I.B. The trial was conducted on North Gower Clay (heavy phase) soil with 3.9% organic material at 6.9 pH.

Treatments were arranged in a randomized complete block design and plot sizes were 16.3 m×1.5 m. There were six replicates. Two treatments timings were applied: Treatment 1 was at the V1 three-leaf stage; Treatment 2 was at V4 six-leaf stage.

The results are shown in the following Tables 6-1 through 6-3.

TABLE 6-1

| | | | | Health Rating |
|---|---|---|---|---|
| | | Population | Height | (1—Poor, |
| Treatment | Rep | (×1000) | (cm) | 10—Excellent) |
| 1 | 1 | 33 | 285 | 9 |
| Foliar application of Roundup | 2 | 31 | 275 | 8 |
| WeatherMaxx at 1.0 L/acre at 3 leaf stage | 3 | 31 | 275 | 8 |
| | 4 | 42 | 285 | 9 |
| | 5 | 32 | 277 | 8 |
| | 6 | 37 | 285 | 8.5 |
| Average | | 34 | 280 | 8.4 |
| 2 | 1 | 35 | 278 | 8.5 |
| Foliar application of Roundup | 2 | 29 | 280 | 8 |
| WeatherMaxx at 1.0 L/acre + | 3 | 32 | 280 | 8 |
| COMPOSITION 2 at 1.0 L/ | 4 | 37 | 282 | 8.5 |
| acre at 3 leaf stage | 5 | 39 | 280 | 8 |
| | 6 | 37 | 277 | 8 |
| Average | | 34 | 280 | 8.2 |
| 3 | 1 | 33 | 278 | 9 |
| Foliar application of Roundup | 2 | 33 | 275 | 8.5 |
| WeatherMaxx at 1.0 L/acre + | 3 | 35 | 280 | 9 |
| COMPOSITION 3 at 1.0 L/ | 4 | 37 | 285 | 9.5 |
| acre at 3 leaf stage | 5 | 35 | 280 | 9.5 |
| | 6 | 35 | 280 | 9 |

| | | | |
|---|---|---|---|
| Average | 34 | 280 | 9.1 |

TABLE 6-2

| | | | | Yield |
|---|---|---|---|---|
| | | Bushel | | (bu/acre |
| | Leaf | Weight | Moisture | at 15% |
| Treatment | Stage | (lb/bu) | (%) | moisture) |
| 1 | V-1 | 53.2 | 17.7 | 194.6 |
| Foliar application of Roundup | V-4 | 53.0 | 17.4 | 205.4 |
| WeatherMaxx at 1.0 L/acre | | | | |
| Average | | 53.1 | 17.6 | 200.0 |
| 2 | V-1 | 53.2 | 17.2 | 218.8 |
| Foliar application of Roundup | V-4 | 53.1 | 17.1 | 221.2 |
| WeatherMaxx at 1.0 L/acre + | | | | |
| COMPOSITION 2 at 1.0 L/acre | | | | |
| Average | | 53.2 | 17.2 | 220.0 |
| 3 | V-1 | 53.3 | 17.6 | 213.1 |
| Foliar application of Roundup | V-4 | 53.1 | 17.1 | 216.5 |
| WeatherMaxx at 1.0 L/acre + | | | | |
| COMPOSITION 3 at 1.0 L/acre | | | | |

| | | | |
|---|---|---|---|
| Average | 53.2 | 17.4 | 214.8 |

### Example 7

Treatments were conducted in Western Canada on Glufosinate resistance Canola to show the influence of simultaneous micronutrient applications with glufosinate on yield.

TABLE 7-1

| Plot | | Dist | Dist | Dist | Comb | | Area | | Wt | bus | Yield |
|---|---|---|---|---|---|---|---|---|---|---|---|
| # | Treatment | m | fact | ft | width | ft2 | fact | Area | (lb) | wt | (bu/ac) |
| 1 | B1 | 235 | 3.28 | 770.8 | 36 | 27748.8 | 43560.2 | 0.637022 | 1960 | 50 | 61.5 |
| 2 | B3 | 235 | 3.28 | 770.8 | 36 | 27748.8 | 43560.2 | 0.637022 | 1690 | 50 | 53.1 |
| 3 | B4 | 235 | 3.28 | 770.8 | 36 | 27748.8 | 43560.2 | 0.637022 | 1700 | 50 | 53.4 |
| 4 | B2 | 235 | 3.28 | 770.8 | 36 | 27748.8 | 43560.2 | 0.637022 | 1820 | 50 | 57.1 |
| 5 | A | 235 | 3.28 | 770.8 | 36 | 27748.8 | 43560.2 | 0.637022 | 1440 | 50 | 45.2 |
| 6 | B2 | 235 | 3.28 | 770.8 | 36 | 27748.8 | 43560.2 | 0.637022 | 1650 | 50 | 51.8 |
| 7 | B4 | 235 | 3.28 | 770.8 | 36 | 27748.8 | 43560.2 | 0.637022 | 1830 | 50 | 57.5 |
| 8 | B1 | 235 | 3.28 | 770.8 | 36 | 27748.8 | 43560.2 | 0.637022 | 2000 | 50 | 62.8 |
| 9 | A | 235 | 3.28 | 770.8 | 36 | 27748.8 | 43560.2 | 0.637022 | 1510 | 50 | 47.4 |
| 10 | B3 | 235 | 3.28 | 770.8 | 36 | 27748.8 | 43560.2 | 0.637022 | 2060 | 50 | 64.7 |
| 11 | A | 235 | 3.28 | 770.8 | 36 | 27748.8 | 43560.2 | 0.637022 | 1530 | 50 | 48.0 |
| 12 | B2 | 235 | 3.28 | 770.8 | 36 | 27748.8 | 43560.2 | 0.637022 | 1850 | 50 | 58.1 |
| 13 | B4 | 235 | 3.28 | 770.8 | 36 | 27748.8 | 43560.2 | 0.637022 | 1910 | 50 | 60.0 |
| 14 | B3 | 235 | 3.28 | 770.8 | 36 | 27748.8 | 43560.2 | 0.637022 | 1860 | 50 | 58.4 |
| 15 | B1 | 235 | 3.28 | 770.8 | 36 | 27748.8 | 43560.2 | 0.637022 | 1840 | 50 | 57.8 |
| 16 | B1 | 235 | 3.28 | 770.8 | 36 | 27748.8 | 43560.2 | 0.637022 | 1940 | 50 | 60.9 |
| 17 | B3 | 235 | 3.28 | 770.8 | 36 | 27748.8 | 43560.2 | 0.637022 | 1900 | 50 | 59.7 |
| 18 | A | 235 | 3.28 | 770.8 | 36 | 27748.8 | 43560.2 | 0.637022 | 1490 | 50 | 46.8 |
| 19 | B2 | 235 | 3.28 | 770.8 | 36 | 27748.8 | 43560.2 | 0.637022 | 1700 | 50 | 53.4 |
| 20 | B4 | 235 | 3.28 | 770.8 | 36 | 27748.8 | 43560.2 | 0.637022 | 1810 | 50 | 56.8 |
| 21 | B1 | 235 | 3.28 | 770.8 | 36 | 27748.8 | 43560.2 | 0.637022 | 1850 | 50 | 58.1 |
| 22 | A | 235 | 3.28 | 770.8 | 36 | 27748.8 | 43560.2 | 0.637022 | 1470 | 50 | 46.2 |
| 23 | B4 | 235 | 3.28 | 770.8 | 36 | 27748.8 | 43560.2 | 0.637022 | 1660 | 50 | 52.1 |
| 24 | B2 | 235 | 3.28 | 770.8 | 36 | 27748.8 | 43560.2 | 0.637022 | 1620 | 50 | 50.9 |
| 25 | B3 | 235 | 3.28 | 770.8 | 36 | 27748.8 | 43560.2 | 0.637022 | 1750 | 50 | 54.9 |
| 26 | B1 | 235 | 3.28 | 770.8 | 36 | 27748.8 | 43560.2 | 0.637022 | 1710 | 50 | 53.7 |
| 27 | B3 | 235 | 3.28 | 770.8 | 36 | 27748.8 | 43560.2 | 0.637022 | 1660 | 50 | 52.1 |
| 28 | B4 | 235 | 3.28 | 770.8 | 36 | 27748.8 | 43560.2 | 0.637022 | 1770 | 50 | 55.6 |
| 29 | B2 | 235 | 3.28 | 770.8 | 36 | 27748.8 | 43560.2 | 0.637022 | 1830 | 50 | 57.5 |
| 30 | A | 235 | 3.28 | 770.8 | 36 | 27748.8 | 43560.2 | 0.637022 | 1500 | 50 | 47.1 |
| 31 | B2 | 235 | 3.28 | 770.8 | 36 | 27748.8 | 43560.2 | 0.637022 | 1670 | 50 | 52.4 |
| 32 | B4 | 235 | 3.28 | 770.8 | 36 | 27748.8 | 43560.2 | 0.637022 | 1770 | 50 | 55.6 |
| 33 | B1 | 235 | 3.28 | 770.8 | 36 | 27748.8 | 43560.2 | 0.637022 | 1790 | 50 | 56.2 |
| 34 | A | 235 | 3.28 | 770.8 | 36 | 27748.8 | 43560.2 | 0.637022 | 1480 | 50 | 46.5 |
| 35 | B3 | 235 | 3.28 | 770.8 | 36 | 27748.8 | 43560.2 | 0.637022 | 1780 | 50 | 55.9 |
| | | T′ | | | | | | | | | |
| | | mt | Mean | | | | | | | | |
| | Summary | code | Yield | | | | | | | | |
| | Control | A | 46.5a | | | | | | | | |
| | Early (3- | B1 | 58.3c | | | | | | | | |
| | 4leaf) | | | | | | | | | | |
| | Normal | B2 | 54.4b | | | | | | | | |
| | (5-6leaf) | | | | | | | | | | |
| | Early/ | B3 | 57.0bc | | | | | | | | |
| | Normal | | | | | | | | | | |
| | 3-4 & 5-6 | | | | | | | | | | |
| | leaf | | | | | | | | | | |
| | Early/ | B4 | 55.8b | | | | | | | | |
| | Normal | | | | | | | | | | |
| | 3-4 & 5-6 | | | | | | | | | | |
| | leaf | | | | | | | | | | |

TABLE 7-2
Treatments were conducted on Glufosinate resistance
Canola to show the effect of simultaneous micronutrient
applications on oil content.

| Glufosinate trial - 2015 | | Plot # | Plot ID | % Oil |
|---|---|---|---|---|
| 229404 | Argentine Canola | Plot 1 | BI | 45.7% |
| 229405 | Argentine Canola | Plot 2 | B3 | 45.2% |
| 229406 | Argentine Canola | Plot 3 | B4 | 45.8% |
| 229407 | Argentine Canola | Plot 4 | B2 | 45.6% |
| 229408 | Argentine Canola | Plot 5 | A | 40.1% |
| 229409 | Argentine Canola | Plot 6 | B2 | 44.7% |
| 229410 | Argentine Canola | Plot 7 | B4 | 45.1% |
| 229411 | Argentine Canola | Plot 8 | B1 | 44.1% |
| 229412 | Argentine Canola | Plot 9 | A | 40.9% |
| 229413 | Argentine Canola | Plot 10 | B3 | 44.6% |
| 229414 | Argentine Canola | Plot 11 | A | 39.9% |
| 229415 | Argentine Canola | Plot 12 | B2 | 45.2% |
| 229416 | Argentine Canola | Plot 13 | B4 | 45.5% |
| 229417 | Argentine Canola | Plot 14 | B3 | 44.8% |
| 229418 | Argentine Canola | Plot 15 | B1 | 44.4% |
| 229419 | Argentine Canola | Plot 16 | B1 | 44.8% |
| 229420 | Argentine Canola | Plot 17 | B3 | 45.2% |
| 229421 | Argentine Canola | Plot 18 | A | 40.4% |
| 229422 | Argentine Canola | Plot 19 | B2 | 44.3% |
| 229423 | Argentine Canola | Plot 20 | B4 | 43.1% |
| 229424 | Argentine Canola | Plot 21 | B1 | 43.6% |
| 229425 | Argentine Canola | Plot 22 | A | 40.5% |
| 229426 | Argentine Canola | Plot 23 | B4 | 45.2% |
| 229427 | Argentine Canola | Plot 24 | B2 | 44.8% |
| 229428 | Argentine Canola | Plot 25 | B3 | 45.6% |
| 229429 | Argentine Canola | Plot 26 | B1 | 45.3% |
| 229430 | Argentine Canola | Plot 27 | B3 | 43.1% |
| 229431 | Argentine Canola | Plot 28 | B4 | 44.4% |
| 229432 | Argentine Canola | Plot 29 | B2 | 45.7% |
| 229433 | Argentine Canola | Plot 30 | A | 41.1% |
| 229434 | Argentine Canola | Plot 31 | B2 | 45.8% |
| 229435 | Argentine Canola | Plot 32 | B4 | 45.2% |
| 229436 | Argentine Canola | Plot 33 | B1 | 45.5% |
| 229437 | Argentine Canola | Plot 34 | A | 40.4% |
| 229438 | Argentine Canola | Plot 35 | B3 | 44.6% |

| | Summary | |
|---|---|---|
| | Treatments | % Oil |
| A | Control | 40.5% a |
| B1 | 3-4 Leaf stage (Early) | 45.0% b |
| B2 | 5-6 Leaf stage | 45.2% b |
| | (Normal) | |
| B3 | Early/Normal | 44.7% b |
| B4 | Early/Normal | 44.9% b |

The Examples with Tables above show the significance of the enhancement of yield as a direct result of the prevention of ion scavenging by glyphosate, glufosinate, 2,4-D and other small organic acid herbicides. The subsequent yield, mineral and oil content in response to said application of Monocarbamide dihydrogen sulfate (MCDS) chelated micronutrients without ammonium release relates to the lack of a delay in growth from acid active application during a period of maximum sunlight. The interference with enzymatic processes within the resistant and/or tolerant plants can negatively affect yield, oil content and plant health.

Many variations of the invention will occur to those skilled in the art. Some variations include liquid formulations. Other variations call for solid formulations. All such variations are intended to be within the scope and spirit of the invention.

Although some embodiments are shown to include certain features or steps, the applicant specifically contemplates that any feature or step disclosed herein may be used together or in combination with any other feature or step in any embodiment of the invention. It is also contemplated that any feature or step may be specifically excluded from any embodiment of the invention.

What is claimed is:

1. A method of enhancing the health of herbicide tolerant and resistant plants comprising applying to the plants a composition comprising the herbicide to which the plant is tolerant, 1 to 99% by weight of monocarbamide dihydrogen sulphate, and one or more micronutrients selected from monovalent, divalent and trivalent cations selected from the cations of calcium, magnesium, manganese, zinc, copper, boron, iron, selenium and molybdenum.

2. The method of claim 1, wherein the composition further comprises
(a) phosphate esters and tallow amine ethoxylates, and wherein the monocarbamide dihydrogen sulphate is present in an amount of about 25 to 35%, the phosphate esters are present in an amount of about 0 to 15%, and tallow amine ethoxylates are present in an amount of about 0 to 15% by weight of the composition; and
(b) Manganese and zinc micronutrients and other micronutrients together comprising about up to about 8% by weight of the composition.

3. The method of claim 2 wherein the composition is applied to herbicide tolerant or resistant corn.

4. The method of claim 2 wherein the composition is applied to herbicide tolerant or resistant soybeans.

5. The method of claim 2 wherein the composition is applied to herbicide tolerant or resistant canola.

6. The method of claim 2 wherein the composition is applied to herbicide tolerant or resistant cereals.

7. The method of claim 2 wherein the composition is applied to herbicide tolerant or resistant cotton.

8. The method of claims 3, 4, 5 and 6 wherein the composition comprises 3,6 dichloro-2-methoxybenzoic acid (Dicamba) or salt thereof.

9. The method of claims 3, 4, 5 and 6 wherein the composition comprises 2,4-Dichlorophenoxyacetic acid (2,4-D) or salt thereof.

10. The method of claims 3, 4, 5 and 6 wherein the composition comprises n-(phosphonomethyl) glycine (Glyphosate) or salt thereof.

11. The method of claims 3, 4, 5 and 6 wherein the composition comprises Glufosinate or salt thereof.

12. The method of claim 1 wherein the composition is made by the addition of the sulfate, oxide, citrate or acid form of the monovalent, divalent and trivalent cations at about a 1:1 ratio of monocarbamide dihydrogen sulphate to a divalent metal ions, and between about 1:1 to about 2:1 ratio for trivalent ions.

13. The method of claim 10, wherein the composition is substantially free of any salt forming ammonium moieties.

14. A composition for enhancing the health of herbicide tolerant or resistant plants comprising
(a) a herbicide selected from auxin herbicides such as 2,4-D, Dicamba, as well as other small organic acid pesticides such as Glyphosate and Glufosinate;
(b) monocarbamide dihydrogen sulphate;
(c) other adjuvants selected from phosphate esters and tallow amine ethoxylates; and
(d) one or more micronutrients selected from monovalent, divalent and trivalent cations selected from cations of calcium, magnesium, manganese, zinc, copper, boron, iron, selenium and molybdenum; and the composition being substantially free of any compounds that result in salt-forming ammonium moieties in the composition.

15. The composition of claim 13 wherein at least one of the herbicides is Dicamba.

16. The composition of claim 13 wherein at least one of the herbicides is 2,4-D.

17. The composition of claim 13 wherein at least one of the herbicides is Glufosinate

18. The composition of claim 13 wherein at least one of the herbicides is Glyphosate

19. The composition of claim 13 wherein at least one of the herbicides is an Auxin.
